(19) United States
(12) Patent Application Publication
(10) Pub. No.: US 2020/0270111 A1
(43) Pub. Date: Aug. 27, 2020

(54) Apparatus and method for manufacturing filled containers

(71) Applicant: KRONES AG, Neutraubling (DE)

(72) Inventors: Gabriel SEIBOLD, Obertraubling (DE); Lisa HERTEL, Regensburg (DE); Tobias STAEBER, Regenstauf (DE); Aurelie BOERMANN, Regensburg (DE); Holger MUELLER, Pentling (DE); Sascha BAUER, Wiesenfelden (DE); Stefan PIANA, Koefering (DE); Stephanie WUNDERLICH, Donaustauf (DE); Ute BEDOE, Landshut (DE); Wolfgang SCHOENBERGER, Brennberg (DE); Ludovic LAINE, Hainsacker (DE); Johannes KUGLER, Nittenau (DE); Daniel Vogler, Neutraubling (DE)

(21) Appl. No.: 16/798,068

(22) Filed: Feb. 21, 2020

(30) Foreign Application Priority Data
Feb. 21, 2019 (DE) 10 2019 104 387.5

(51) Int. Cl. B67C 3/26; B67C 7/00; B67C 3/24

(52) U.S. Cl. CPC B67C 3/26; B67C 3/24; B67C 7/00

(57) ABSTRACT

An apparatus for manufacturing filled containers includes a transport unit that is suitable and designed for transporting containers that are filled with a liquid and are closed with a closure cap. The apparatus includes a penetration unit that is suitable and designed for generating an opening in at least an area of the closure cap and/or of the container, and an application unit that applies a flowable and in particular gaseous medium onto an internal space of the container through this opening (or feeds gaseous medium into this intern space). Further the apparatus includes a closing unit that re-closes the opening.

The present invention relates to an apparatus and a method for manufacturing filled containers. From the prior art, a large number of such apparatus and methods are known. Usually, a container is initially filed with a liquid and is subsequently closed with a closure cap. In the prior art, methods are known wherein an inert gas is filled into the head space of the containers in the case of containers that have not yet been closed, in order to extend in this way the shelf life of the corresponding beverage. This approach is known in particular in the case of so-called hot-fill processes, wherein a heated liquid is filled into the containers.

More recently, however, methods have also become known wherein the containers are initially closed, for example using a plastic closure cap, this plastic closure cap is subsequently pierced again, and the inert gas is filled into the head space of the container through the opening thus produced. Subsequently, the generated opening is closed up again.

Although on the one hand these approaches are promising, however, so far they are not yet ready for series production.

The present invention is therefore based on the object of making such apparatus known from the prior art ready for series production.

According to the invention, this is achieved by means of the subject matters of the independent claims. Advantageous embodiments and further developments are the subject of the dependent claims.

An apparatus according to the invention for manufacturing filled containers includes a transport unit that is suitable and designed for transporting containers filled with a liquid and closed with a closure cap.

Further, the apparatus includes a penetration unit that is suitable and designed for producing an opening in at least an area of the closure cap and/or of the container, and an application unit that applies a flowable and in particular gaseous medium onto an internal space of the container (or supplies the gaseous medium to this internal space) through this opening.

Preferably, the closure caps are closure caps that were manufactured using a compression moulding process. In a further preferred apparatus, these are closure caps that have a continuous or essentially continuous wall thickness.

Moreover it would also be conceivable to use closure caps that were produced using an injection moulding process.

In a further approach, the closure cap is formed in one layer. Preferably, the closure cap does not have a so-called liner on the inside thereof.

Further, the apparatus has a closing unit that re-closes the opening (and that re-closes the opening in particular after the gaseous medium has been applied to the internal space).

It is pointed out that on the basis of the basic design of the machine as described above, further embodiments according to the invention are possible. The applicant reserves the right to claim such embodiments, if necessary, in the context of further patent applications and in particular of further divisional applications. The description following below does not conclusively describe individual embodiments according to the invention. The applicant therefore reserves the right to claim, also independently of the embodiments described below, further subject matters on the basis of the basic design described here.

In a first embodiment according to the invention, the apparatus includes a sterilisation unit that sterilises at least an area of the closure cap and/or of the container. In this embodiment, the circumstance is taken into account that due to the production of the opening and the subsequent open condition of the container, contamination or germination of the beverage may occur.

For this reason it is proposed to sterilise at least an area of the container or of the closure cap (in particular the area into which said opening will be or was introduced). In particular, this is an area of the outer wall. This sterilisation may be carried out, as mentioned below, in different ways, such as by heating or by means of UV radiation or the like.

This first measure according to the invention allows in particular readiness for series production for corresponding plants to be achieved, because in this way, as will be explained in more detail below, also a series or industrial production of containers will be made possible.

In a preferred method, the containers are filled with a heated liquid and in particular with a heated beverage. Preferably, when being filled in, the liquid has a temperature that is higher than 30°, preferably higher than 40°, preferably higher than 50° and particularly preferably higher than 70°.

In a second embodiment according to the invention, the closing unit includes an ultrasound generation unit.

This approach, too, allows a reliable closure to be ensured. From the applicant's internal prior art, closing units are known which re-heat the area of the opening of the lid for example by heating. In this case, however, only a certain area of the lid is heated and welded in this way. As a result of the use of an ultrasound generation unit, a more reliable welding of the produced opening may be achieved, above all as a result of the fact that the welding is carried out lower down in the material. Welding using ultrasound also prevents the formation of poisonous gases, as is the case during heat melting. Moreover, no molten material can drip off from the lid into the container.

In a further embodiment according to the invention, the apparatus includes at least one inspection unit that monitors at least one unit of the apparatus, and/or the apparatus includes at least one monitoring unit that monitors at least one parameter that is characteristic of the manufacture of the filed containers. In this embodiment, too, the operational reliability or the process reliability of the containers thus produced is enhanced. Moreover, this measure also contributes to the containers being manufactured during on-going production.

In a further embodiment according to the invention, the apparatus includes at least one cleaning and/or sterilisation unit that is suitable and designed for cleaning and/or sterilising at least one unit of the application unit (and/or of the penetration unit).

In this embodiment it is assumed that the application unit (and/or the penetration unit) includes for example components to be cleaned or to be sterilised, such as feed lines for a gaseous medium or the like. Depending on the application, for example depending on the filled component, a different degree of cleaning or sterilisation may be required. Correspondingly, also different cleaning and/or sterilisation media may be used.

Preferably, this cleaning and/or sterilisation unit will be active during a cleaning operation that differs from a usual working operation in which the containers themselves are treated.

Further, it is also possible for the cleaning and/or sterilisation unit to clean or sterilise other components of the apparatus, such as for instance also the penetration unit or the closing unit.

In a further embodiment according to the invention, the application unit allows the application of a first pressure and a second pressure that differs from the first pressure onto the containers. In this approach, it is in principle proposed that the medium is supplied through the opening with different pressures.

As mentioned above, in such processes, containers and in particular hot-filled containers are generally pierced through the closure cap after re-cooling, and a gaseous medium, in particular an inert gas and in particular nitrogen, is applied thereto under pressure.

As mentioned above, this is carried out in order to restore the shape of instable containers that have “collapsed” after re-cooling using the cooled-down head space gas, and also to make them stackable. In this embodiment it is proposed, in order to get gas into the head space of the pierced bottle as quickly as possible, to quickly feed gas into the head space initially under a high pressure, in order to keep the process time and thus also a possible corresponding machine as small as possible. Subsequently, the desired final pressure in the head space is adjusted using a small, substantially lower pressure.

Preferably, a first pressure is a pressure that is greater than 2 bar, preferably greater than 2.5 bar, preferably greater than 3 bar and preferably greater than 3.5 bar.

Preferably, the first pressure is a pressure that is lower than 10 bar, preferably lower than 9 bar, preferably lower than 8 bar, preferably lower than 7 bar and preferably lower than 6 bar. Particularly preferably, it is a pressure that is in the order of approximately 4 bar.

The second pressure is in particular a pressure that defines the desired final pressure in the head space. This may for example be a pressure of 0.3 bar (overpressure), i.e. 1.3 bar. Preferably, this second pressure is greater than 0.1 bar (overpressure), preferably greater than 0.2 bar (overpressure) and particularly preferably greater than 0.25 bar (overpressure).

Preferably, this second pressure is lower than 3 bar (overpressure), preferably lower than 2.5 bar (overpressure), preferably lower than 2 bar (overpressure), preferably lower than 1.5 bar (overpressure), preferably lower than 1 bar (overpressure) and preferably lower than 0.5 bar (overpressure).

The pressures mentioned here may subsequently also be referred to as pressures stages.

In a preferred embodiment, the closing unit is also movable and can in particular be moved towards the container. For example, the closing unit may be a rod-like body, the tip of which has been heated and which can be moved towards the container. Preferably, the closing unit can be moved in a straight direction of movement in the course of this, this direction of movement is preferably at an angle to a longitudinal direction of the container to be treated.

Preferably, the closure cap of the container is a plastic closure cap. In a further preferred embodiment, the container itself is also a plastic container and in particular a deformable plastic container.

In a further preferred embodiment, the sterilisation unit is suitable and designed for sterilising at least an area of the opening. This contributes towards ensuring that no contaminations or germs can get into the inside of the container through this area.

In a further advantageous embodiment, the sterilisation unit has a radiation unit that applies electromagnetic radiation and in particular high energy light, for example high energy UV light, onto at least an area of the container, and/or a heating unit that heats at least an area of the container. In this embodiment, two different approaches for sterlisation are proposed, mainly on the one hand the heating of in particular an area of the opening and/or the radiation with light. This electromagnetic radiation may for example be ultraviolet radiation, but may also be electron radiation, X-ray radiation or radioactive radiation.

Moreover, however, sterlilsation is also possible by applying a gas, for example a sterile gas or a sterilisation gas such as for example H₂O₂ onto the closure cap. It is also possible to carry out sterilisation in such a way that the process of manufacturing the opening in the closure cap is also carried out during the application of a sterilising gas.

In a further preferred embodiment, the sterilisation unit includes a heating unit that can be moved towards the area of the closure cap and/or of the container to be sterilised, in order to sterilise this area. This infeed operation may here be carried out by means of moving the sterilisation unit, however, also by moving the container.

Preferably, the sterilisation unit is designed as a stamp that can be lowered down onto the closure cap. Particularly preferably, a drive unit is provided that moves at least one component of the sterilisation unit towards the closure cap. This may for example be an electric drive, a hydraulic drive or a pneumatic drive. Particularly preferably, a pneumatic drive is used.

In a further advantageous embodiment, the apparatus includes a control unit that causes the sterilisation unit to sterilise the area of the container and/or of the closure cap, once the perforation unit has introduced the hole. This means that initially the hole is introduced and subsequently the area is sterilised, for example is heated or has UV light applied thereto. It is also possible here for a mechanical coupling to be present between the perforation unit (for example a needle) and the sterilisation unit.

In a further advantageous embodiment, the apparatus has a sterile space, within which the containers are transported at least in sections. It is also possible here for the entire apparatus to be arranged within a sterile space, however it would also be possible to route the transport path of the containers and/or the containers within the sterile space, but for other areas of the apparatus, such as parts of the transport unit, to be positioned outside of this sterile space. Thus, for example, the sterile space could surround the containers like a torus.

Preferably, the sterile space is delimited against an (non-sterile) environment by means of a wall. Preferably, the sterile space is delimited against the (nonsterile) environment by means of at least two walls, which walls are particularly preferably movable relative to each other.

Preferably, a sterlisation unit is provided that sterilises the containers and/or the closure caps already before the actual apparatus.

For example, it would be possible for sterilisation to be carried out by means of H₂O₂ or peracetic acid, if necessary also using electromagnetic radiation before the actual apparatus, for example in an inlet tunnel. In the course of this, the lid and/or the entire containers may be sterilised for example in an H₂O₂ tunnel. In order to avoid re-germination of the closure caps and/or of the containers, the apparatus is designed, in the embodiment described above, in a sterile space and/or using isolator technology.

Preferably, at least one ventilation unit is provided that applies an overpressure of a gaseous medium, in particular however not exclusively sterile air, onto this isolator or the internal space thereof. In this way, any ingress of germs into the isolator or the sterile space may be avoided. Moreover, also a sterilising gas in particular at a low concentration may be present in the isolator or the clean room, in order to avoid germination. H₂O₂ may also be used for sterilising the corresponding feed lines, for example the lines leading into the clean room. The same also applies to the process head.

In a further preferred embodiment, the apparatus has a cleaning unit for cleaning the apparatus itself, such as a so-called CIP (cleaning in place). A cleaning operation may be provided, during which the apparatus cleans itself.

In a further preferred approach or a hygiene concept, lid sterillsation, in particular in the inlet area, using pulse light is provided, wherein one or several lids may be sterilised at the same time. In this case, the apparatus has a radiation unit that is suitable for outputting pulsed radiation, such as UV radiation, electron radiation, X-ray radiation or the like.

In order to avoid re-germination of the lid, it is preferred to equip the apparatus with a clean room cover that generates a corresponding air flow of sterile air. In order to sterilise the corresponding supply lines and the process head, for example hot vapour is used.

Moreover, the apparatus preferably comprises a drying unit that allows the drying of units of the apparatus after the sterilisation thereof. It would thus be conceivable to dry the system again after sterilisation (for example with hot vapour) using an airflow.

In a further preferred embodiment, the transport unit transports the containers individually. In particular, the containers are grasped individually. In this context it is possible for the transport unit to grasp the containers at least also by the neck or the mouth thereof.

In a further advantageous embodiment, the opening is closed as a result of a material modification and in particular as a result of (sectional) melting of the plastic material of the closure cap and/or of the container.

In a further advantageous embodiment, the penetration unit has a piercing unit and in particular a needle. This may be implemented for example as a solid needle or as a hollow needle.

Preferably, the transport unit is formed as a revolving unit. In a further advantageous embodiment, the application unit is suitable and designed for applying an overpressure of a gaseous medium onto the head space of the container or onto the container. An overpressure of for example 3 or 4 bar may be used here.

In a further advantageous embodiment, the closing unit has an infeed unit that feeds at least a component of the ultrasound generation unit towards the opening. This infeed unit may include a drive that is selected from a group consisting of electrical drives, hydraulic drives and pneumatic drives. Particularly preferably, the infeed unit includes a pneumatic drive.

Particularly preferably, the infeed unit is suitable and designed for feeding an ultrasound component fully to the container, which means in such a way that it comes in contact with the container. However, it would also be possible to keep a distance (in particular a small distance) between the container and the ultrasound generation unit.

In a further advantageous embodiment, the ultrasound generation unit includes a sonotrode.

In a further preferred embodiment, the ultrasound generation unit is integrated in a stamp that contacts the container and/or the closure cap at least at times. Preferably, this stamp may be fed towards the container and in particular towards the opening to be closed and the environment thereof, and the ultrasound signal may be activated. Particularly preferably, the apparatus includes an ultrasound generation unit that is suitable and designed for generating the ultrasound signal that excites said sonotrode and another ultrasound generation component.

However, it would also be possible and preferred to activate the ultrasound signal already before the stamp is fed towards the container. In this way, the process time may be kept short or as short as possible.

In a further advantageous embodiment, the ultrasound generation unit includes a piezoelectric element.

In a further advantageous embodiment, the ultrasound generation unit includes a generator unit that is suitable and designed for generating an ultrasound, the frequency of which is greater than 20 kHz, and/or the ultrasound generation unit includes a generator unit that is suitable and designed for generating an ultrasound, the frequency of which is less than 35 kHz. However, it would also be possible to use different frequencies, such as frequencies in the order of 70 kHz.

In a further advantageous embodiment, the apparatus includes a sensor unit that determines, at least partially or at least at times, a parameter that is characteristic of the ultrasonic welding process. In the course of this, for example heating of the plastic material may be determined, however it may also be determined whether the sonotrode is active or whether an ultrasound signal is output. In other words, it is possible for these sensors to monitor both the ultrasound and the respective welding result at the point of welding.

Thus, for example, it may be checked whether an ultrasound signal is present, or an indirect check may be carried out for example using electric currents. In a preferred embodiment, the sensor unit includes a power measurement unit.

In a further preferred embodiment, the ultrasound generation unit includes a processing head that can be fed towards the closure cap and/or the opening, which processing head in turn has a surface that can be turned towards the opening and/or can be fed towards the opening, which surface is formed in such a way that it is suitable for urging molten material in the direction of the opening.

As described above, a sonotrode is used for ultrasonic welding, for example of a hole pierced into the lid. This is fed towards the lid, as mentioned above, in order to re-close the hole located there by means of melting the material using ultrasound.

The applicant has determined that whilst in the case of certain forms of this sonotrode, an appealing weld may be achieved, however due to a certain form of the sonotrode, for example a circular form of the tip, it cannot always be guaranteed that the present hole is welded up. The reason is that whilst certain forms of the sonotrode melt the material up, however the molten material is carried away from the pierced hole. The described embodiment therefore proposes to guide the molten material in particular through the geometric surface shape in such a way that the molten material is urged in the direction of the opening.

The applicant reserves the right to claim independent protection for such an embodiment and in particular for a sonotrode having the form as described here.

The surface that can be turned towards the opening is understood to be that component or in particular that front face of the sonotrode that is located, during the working process, the closest to, or at the least distance from, the opening. It is proposed to design this surface in such a way that it urges molten material in the direction of the opening.

Preferably, this surface is curved and is curved in particular to be concave. As will be described below in greater detail, as a result of this curved surface urging of the molten material in the direction of the opening is achieved. Instead of a curved embodiment, however, an angled embodiment would also be possible, such as in the shape of a cone or the like.

Particularly preferably, this surface of the sonotrode has an opening edge, and in particular also an area that is retracted relative to this opening edge, which means an area that, unlike the opening edge, is further away from the opening to be sealed, and in particular a longitudinal direction of the sonotrode is further away from the opening to be melted than the opening edge.

In a further preferred embodiment, the opening edge may be made to rest, at least in sections and preferably circumferentially, against the closure cap and in particular against the area surrounding the opening.

Particularly preferably, the processing head is designed in the area in which it is placed against the opening, in the form of a hollow, an edge of which hollow may be made to rest against the lids.

Any material melted within this edge is urged into the opening, as will be shown in more detail below.

In a further preferred embodiment, said surface has a spherical shape, such as a hollow hemispherical shape or the like. However, other spherical recesses or hollows would also be possible, such as mentioned above in the form of a cone, a truncated cone or an ellipsoid.

In a further preferred embodiment, a second processing head equipped in the same way is provided.

As mentioned above, the sonotrode form described here has a concave tip form.

Since the ultrasound generation unit, in particular in the form of a sonotrode, is an acoustic component, it is advantageous for t to be symmetrically designed. It is therefore to be recommended that the concave configuration described here is present on several sides, in particular on two sides of the sonotrode. In this way, symmetry of the sonotrode may be achieved.

As mentioned, the molten material is carried over the hole to be closed by the concave head and in particular by the concave tip during melting, so that a certain layer thickness would always be found over the hole to be closed. In this way, in particular by means of a concave shape of the sonotrode, a more reliable welding and/or re-closure of the hole in the container, or the closure cap thereof, may be guaranteed because during any welding operation, edge material is carried and/or pushed directly over the hole. Particularly preferably, the surface of the sonotrode that contacts the lid is symmetrical and circular, in particular in cross section.

In a preferred embodiment, the surface has a shape in the form of a sphere or a sphere segment.

In a further preferred embodiment, the ultrasound generation unit can be fed towards the opening in such a way that the longitudinal direction of the ultrasound generation unit encloses an angle relative to a direction perpendicular to a surface of the closure cap, which is greater than five degrees, preferably greater than ten degrees, preferably greater than 15 degrees and preferably greater than 17 degrees.

In a further preferred embodiment, this angle that is enclosed by the longitudinal direction of the ultrasound generation unit relative to a direction perpendicular to the surface of the closure cap is less than 50 degrees, preferably less than 40 degrees, preferably less than 30 degrees and preferably less than 23 degrees.

In a further preferred embodiment, said longitudinal direction of the ultrasound generation unit is also the infeed direction, which means the direction in which the ultrasound generation unit is moved relative to the closure cap.

In a further advantageous embodiment, the apparatus includes several transport units that are preferably successively arranged and that transport the containers. Thus, for example, the container may be moved towards the apparatus described here using a further transport unit. It is also possible here to carry out a hand-over operation of changing from a bottom-guided transport of the containers to a neck-guided transport of the containers.

In a further advantageous embodiment, the apparatus has an individualisation unit that transfers the stream of containers into consecutive individual containers. Thus, for example, an infeed screw may be provided in the inlet of a machine.

Moreover, a screw-less inlet would also be possible. It is possible here for the containers to be handed over to one or more inlet stars, depending on the machine configuration. In a further preferred embodiment, the individual containers are also lifted or lowered, if necessary, in order to achieve a unitary level for the handover into a container treatment or container transport area. It is possible here for a lifting of the containers to be carried out using for example lifting cams on a neck ring.

Moreover, also a lifting star may be provided. It may also be conceivable for the containers to be held down during the transport thereof or for a lowering cam to be provided. Moreover, it is also possible for the containers to fall in free fall over a certain (in particular small) drop distance or for a level neck-handling guide to be provided.

In a further advantageous embodiment, a handover into a neck treatment clamp is carried out. To this end, if necessary, additional guides may be provided, in particular in the area of a handover and preferably also with an engagement in a closure cap area or in an area in which the containers are transported by their necks.

In a further preferred embodiment, the sterilisation unit is designed in such a way that it allows sterilisation of the closure cap or of the lid with the containers closed. It is possible here for the container lid to be sterilised already in the closed condition for the process. This may be made possible via one or more dry or wet procedures. As mentioned above, sterilisation may be carried out for example using ultraviolet light, H₂O₂, chlorine dioxide, hot vapour, peracetic acid, but also electron rays and the like.

In a further preferred embodiment, a sterilisation unit is also provided that sterilises the penetration unit or the piercing unit, for example a needle. Such sterilisation may be carried out using for example a temperature or a heating and/or via a sterilisation medium, such as for example ultraviolet light, H₂O₂, chlorine dioxide, hot vapour, and/or the penetration unit may be kept sterile using corresponding approaches.

In a preferred embodiment it is possible for the procedures or processes to be carried out in a linear machine. Thus, for example, containers may be treated directly on a transporter. Thus, corresponding process heads may be transported for example above or below a drag chain via a linear motor, via a pneumatic guide or the like. Further, both a continuous operation of the transport unit and a cyclic operation are possible.

Several variants are conceivable for sterilisation using a gas and for example H₂O₂. Thus, for example, an H₂O₂ reservoir may be provided in the application unit, for example in the application head. Moreover, a pulse light may also be integrated in the head in particular during application of UV light. In the embodiment with H₂O₂ in a head, sterilisation of the head and of the attachments with H₂O₂ is conceivable. Further, it is also preferred if after attachment on the container, an interior zone of the container is rinsed with H₂O₂, in order to sterilise this area.

In the embodiment with light pulses, for example with ultraviolet pulses, sterilisation of the head and of the attachments using UV light may be provided. Further, after attachment on the container, the interior zone of a container may be treated with UV light, in order to sterilise this area.

During sterilisation with other media, such as for example chlorine dioxide, peracetic acid, or during sterlisation using electron rays, it is conceivable to keep a head of the application unit sterile using temperature.

In the case of chlorine dioxide wet sterilisation of for example the lid using the effect of ClO₂, it would also be conceivable to carry out sterilisation before the actual apparatus. Thus, corresponding sterilisation may be carried out already before a heat exchanger upstream of the apparatus described here.

Sterilisation using electron radiation (E-beam) of the lid may be provided either in an inlet area of the apparatus or directly in the head of the application unit.

In the case of sterilisation using peracetic acid or in the case of wet sterilisation of the lid or of the containers, sterilisation within an isolator is also conceivable. In this case, sterilisation both of the isolator and of the feed lines may be carried out. This, too, may if necessary be carried out using peracetic acid.

In a further advantageous embodiment, the inspection unit and/or the monitoring unit s/are suitable and designed for outputting at least one value that is characteristic of the set-up of the apparatus and/or of the manufacturing of the filled containers.

Particularly preferably, the value that is characteristic of the set-up of the apparatus is selected from a group of values that includes a value that is characteristic of a physical property of the penetration unit, a value that is characteristic of a positioning of the penetration unit relative to the container and/or to the closure cap, a value that is characteristic of a relative movement between the penetration unit and the container, a value that is characteristic of a focusing of a light bundle, a value that is characteristic of the application unit, a value that is characteristic of the closing unit, in particular a temperature value or the like.

It is therefore proposed to determine such values that are relevant for a reliable penetration and/or application and/or sterilisation and/or closing process. This may for example be the condition of a penetration needle; for example, it may be checked whether this is broken off or is still generally intact. It is also possible to determine several values.

Moreover, the concentration of a sterilisation agent may also be measured.

In a further advantageous embodiment, the inspection unit and/or the monitoring unit include(s) a sensor unit that is selected from a group of sensor units that includes temperature sensors, pressure sensors, acceleration sensors, motion sensors, distance sensors, acoustic sensors, proximity sensors and the like.

In a further advantageous embodiment, the apparatus includes a storage unit that stores the values output by the respective sensor unit. Moreover, a comparison unit is preferably provided which compares the values output by the one or more sensor units with reference values, in particular with reference values stored in a database.

In a further advantageous embodiment, the apparatus may include a control and/or regulating unit that controls the apparatus under consideration of the values output by the one or more sensor unit(s).

In a further preferred embodiment, the value that is characteristic of the manufacture of the filled containers is selected from a group of values that includes temperature values, pressure values, in particular a pressure value inside the container, speeds, accelerations, optical characteristic variables and the like. This may for example be the temperature of the liquid in the container or the temperature of a welding stamp that seals the produced opening. Moreover, such values may also be captured over a longer period of time. It is also possible to use such values for creating a prognosis in relation to a wear condition.

Moreover, it is possible to carry out an optical inspection of the puncture for example in a container closure cap.

Further, a temperature measurement may be carried out, for example a temperature measurement of a sealing point.

Moreover, it is possible to carry out measurements, such as pressure measurements, on the container before or after the performance of the respective procedure.

In a further preferred embodiment, the inspection unit is suitable and designed for determining the respective value in a contactless manner. The inspection unit may therefore for example be a camera or a proximity sensor or the like.

In a further advantageous embodiment, the apparatus includes a fault generation unit that is suitable and designed for generating operation faults. In this case it is proposed that initially, a fault is deliberately generated in order to check the inspection unit, which means the inspection unit must then be able to detect this fault. In this way, it is for example possible to generate a faulty seal deliberately, in order to check the downstream inspection unit, i.e. to check it in terms of whether it is able to detect this fault.

In a preferred approach, a needle inspection may be carried out between an inlet star of the containers and an outlet star of the containers. It would thus be conceivable to briefly extend the penetration unit, for example a needle, so as to be captured by at least one camera, preferably two cameras, which are preferably offset relative to each other at a predefined angle.

Since in practice faults will only rarely be found or reported using such an inspection, a self-check is advantageous. This may be carried out for example by not extending the needle in intervals, whilst the camera then has to report this provoked fault as evidence for a correct inspection function.

In a preferred embodiment, an inspection unit is provided that allows thermal monitoring of the welding point. Thus, for example sensors such as infrared cameras or thermopiles may be provided, which check after welding whether a local heating by a minimum temperature difference can be measured on the welding point.

Moreover, it is also possible and preferred if the penetration unit is inspected and/or checked. Thus, for example a needle, the penetration hole produced by this needle and/or the form of a welding point may be checked. In this context, for example a detection of the position of the hole and/or of the welding point in relation to an outer edge of the closure cap, a circularity of the hole and/or of the welding point, the diameter of the hole and/or of the welding point, a curvature of the hole and/or of the welding point on the closure cap is conceivable.

Preferably, the inspection unit includes an image capturing unit such as in particular, but not exclusively, a camera that observes the puncture hole and/or the welding point. This image capturing unit may be provided in particular above the container closure cap.

Preferably, the apparatus includes an inspection unit that is used to check the closure cap and/or the internal pressure of the container. This may be carried out for example via a bulging of the container closure cap. This inspection unit may here include for example an optical means. Thus, for example, a one-point laser triangulation sensor may be provided that captures a height profile of the closure cap and in particular of the closure cap passing there below.

From a curvature or a recorded measurement curve, a conclusion may be made in respect of the internal pressure and thus for example of any leakage. Even if the bulge changes or “drifts off” due to slowly changing ambient conditions, individual or strongly deviating profiles may be detected. The detection is even more robust (albeit more complex) when an extensive surface profile of the closure caps is captured.

As mentioned, also the penetration unit, which may include for example a needle, may be optically inspected. Preferably, therefore, an inspection unit is provided that inspects, in particular optically, at least one component of the penetration unit. Preferably, the penetration unit or the needle is investigated with regard to a property that is selected from a group of properties including bending of the needle, bluntness of the needle, a possibly existing needle breakage, a position or the length of the needle, the presence of residues on the needle and/or the presence of contaminations on the needle.

Specifically, when units such as those for sterilisation, for penetration or for re-closing are present multiple times, as this is typically the case in revolving machines, it is proposed to monitor these units individually and in particular to carry out an individual statistical monitoring thereof. To this end, a plurality of measurements of one or more properties may be statistically aggregated for each individual unit, in order to be able to detect in good time deviations with a view to preventative maintenance, before these influence the production. The statistic aggregation, or for example an averaging over many measurement values, allows a substantially higher degree of accuracy compared to individual measurements. If then even trends are derived from time series, the reaching of a wear limit, for example, may be predicted early on.

The present invention is further directed to an apparatus for manufacturing filled containers having a transport unit that is suitable and designed for transporting containers that are filled with a liquid and are closed with a closure cap. Further, a penetration unit is provided that is suitable and designed for generating an opening in at least one area of the closure cap and/or at least one area of the container, and which also applies a flowable and in particular gaseous medium onto an internal space of the container through this opening. Further, a closing unit is provided which closes the opening.

According to the invention, the apparatus includes a replacement unit that is suitable and designed for replacing at least one unit of the apparatus.

This may be for example a component of the penetration unit, such as a needle or the like. Further, this unit of the apparatus may be a component of the application unit or a component of the closing unit.

Preferably, this replacement unit is suitable and designed for automatically carrying out the designated replacement. Thus, it is possible, in the case of damage to the penetration unit, for example the needle, to automatically replace the latter.

In a further advantageous embodiment, the apparatus includes a storage unit for storing at least one and preferably several of such components, such as for example one or more corresponding needles. This storage unit or this magazine may be located in a certain position, so that in the case of a damaged needle or penetration unit, this position may be move to and a replacement may be carried out via a replacement system and/or a robot.

Moreover, it is also possible for the replacement unit itself to be integrated in the penetration unit. Thus, for example, a magazine may be located in the process head, which in the case of damage to a needle replaces the latter. Thus, for example, a damaged needle may be ejected and replaced with a new one.

Generally, the penetration unit and the closing unit may be arranged and/or moved in different ways. Thus, it would be conceivable for both the penetration unit and the closing unit to be fed towards the container and/or the container closure cap in the same direction of movement. The penetration unit and the closing unit might here be disposed for example on a carrier that is designed as a revolving drum.

Moreover, the directions of the respective feeding movements may extend at angles relative to each other that differ from 0°, or may be oblique. It would be possible for one of the two components to be perpendicular to the container and/or closure wall, however it would also be possible for both components to be disposed at an angle relative to the respective wall to be pierced.

In order to avoid that as a result of an angled impact on the section to be pierced and/or to be closed transverse forces occur, the two units may be placed perpendicularly onto the surface to be pierced. Preferably, in this case a movement unit is provided which moves at least one of the two units at least also in a direction that is perpendicular to the piercing direction, such as the revolver drum type unit mentioned above.

In other words, a reciprocal movement of the components may preferably be carried out that can take place for example via a horizontal displacement of the penetration unit and/or of the closing unit or may be realised by way of a rotary movement.

Moreover, also the container itself may be moved in particular transversely, in particular perpendicular in relation to its longitudinal direction relative to the penetration unit and/or to the closing unit.

Particularly preferably, several stations are provided on the transport unit, each of which preferably has the units mentioned above, i.e. each of which has an application unit, a penetration unit and/or a closing unit.

Particularly preferably, the cleaning and/or sterilisation unit is suitable for applying a flowable cleaning medium onto the units of the application unit(s), as will be described in more detail below.

In a further embodiment according to the invention, the application unit allows at least a first pressure and a second pressure, which differs from the first pressure, to be applied onto the containers. For example, it is possible to apply initially a greater overpressure, for example a pressure of 4 bar, onto the container, and subsequently a pressure that will then substantially correspond to the internal pressure of the container, for example a pressure of 1.3 bar (or 0.3 bar overpressure relative to ambient pressure). In particular, this is the pressure of the flowable medium that is introduced into the container through the opening made therein.

In a preferred embodiment, the application unit has at least one feed line that feeds the medium to the internal space of the container, and the sterilisation unit is suitable and designed for rinsing this feed line with a cleaning and/or sterilisation medium. Particularly preferably, the application unit includes at least two feed lines that feed flowable medium to the internal space of the container, and the sterilisation unit is suitable and designed for rinsing both feed lines with the cleaning and/or sterilisation medium.

Moreover, the application unit may include an application space that is in interference communication with the internal space of the container and into which the at least one, preferably both feed lines lead.

In a further advantageous embodiment, the cleaning and/or sterilisation unit has at least one supply unit for a cleaning and/or sterilisation medium, which is designed to be stationary. It is possible here for such feed lines or a corresponding reservoir for the cleaning and/or sterilisation agent to be provided in a stationary area of the machine, and in particular for this cleaning and/or sterilisation agent to be transported to a movable part of the apparatus.

In a further preferred embodiment, the application unit is provided on the transport unit. This means that the application unit will be transported using the transport unit.

Particularly preferably, the apparatus includes a plurality of such application units. Thus, for example, a plurality of corresponding stations may be provided, on which, as mentioned above, in each case penetration units, application units and/or closing units are provided.

In a further advantageous embodiment, the apparatus includes a distribution unit that distributes at least one flowable medium from a feed unit, which is arranged to be stationary, towards a plurality of application units. In particular, this distribution medium may be a so-called rotary distributor which, starting from a stationary feed, divides a plurality of application units that are provided on the transport unit and are thus movable.

It is however possible here for the actual sterilisation or cleaning to be carried out in a stationary condition of the application units. Further, it is also possible that the distribution unit mentioned is also suitable and designed to distribute during operation the flowable medium from a stationary plant component to the individual application units.

In a further advantageous embodiment, the apparatus includes a provisioning unit, disposed to be stationary, for providing the flowable medium. Thus, it is also possible for the flowable medium to be applied onto the containers during working operation, to be transferred, starting from a stationary part of the system, to a movable and in particular rotating part of the system.

In a further advantageous embodiment, the apparatus includes a selection unit and/or a switching unit that allows the selective loading of the application unit with the flowable medium or the cleaning and/or sterilisation medium. It is possible here for the apparatus, as will be described in more detail below, to include two different working operations and for the selection unit, such as a valve, to be able to cause the flowable medium or the cleaning and/or sterilisation medium to be applied to the application unit.

In a further preferred embodiment, the flowable medium (which is used for sterilisation and/or cleaning) may be a gaseous medium and in particular a medium such as vapour, hydrogen peroxide or the like. However, it would also be possible to carry out sterilisation using a liquid medium.

In a preferred embodiment, at least one of the pressures (mentioned above) or one of the pressure stages (which are applied to the container) is made available using a pressure storage unit.

In particular, in the case of the use of a rotary machine, there is generally a need to transfer the two pressure stages onto the rotary part of the machine or to reduce the pressure during rotation, in particular in order to keep a corresponding media distributor simple.

However, a pressure reduction during rotation is possible only to a limited extent since the internal fittings, especially a pressure reducer, are not hygienic components and therefore the entire line cannot be damped for maintaining hygiene.

If a pressure reduction is carried out using a valve node and transfer into the rotary part of the machine is carried out using separate lines, then this would lead to a complex design of the media distributor.

Moreover, a reduction of pressure in one line and a subsequent take-off still requires a highly accurate adjustment and tuning of controllers because a take-off would have an immediate effect on the volume present in the pipe. The pressure then frequently fluctuates, so that subsequently not the same pressure is present in the head space of each container.

The embodiment mentioned above therefore proposes to provide a pressure reservoir on the rotary part or the movable part of the system. More specifically, this idea is based on the assumption that only one line with a pressure level of approximately the lower pressure or the higher pressure is passed through a media distributor.

In the rotary part, a pressure reservoir is then filled with a high volume at the higher pressure p1 via a control valve (which can preferably be damped). This pressure reservoir may for example be implemented as an annular reservoir. Thus, the pressure storage unit will then preferably provide the higher pressure. This pressure reservoir may, as mentioned above, be implemented as an annular line and may include several interdependent separate stations.

In a preferred embodiment, the pressure storage unit is provided at a unit of the transport unit. Thus, for example, as mentioned above, a rotary wheel may be provided in the case of a carousel, on which in turn the pressure reservoir is provided. On this wheel, also several of the stations mentioned above may be provided, which are used for treating the containers.

In a further preferred embodiment, the apparatus includes a plurality of application units, and preferably, several of these application units are supplied with at least one pressure from a common pressure storage unit.

In a further preferred embodiment, a pressure is also made available by a supply unit that is arranged to be stationary. In particular, this is here the lower pressure. This will preferably be distributed to the individual stations by means of a distribution unit, for example a so-called rotary distributor.

Preferably, the higher pressure is made available or delivered via a rotary distributor. This pressure can be reduced using a reduction unit, for example by means of a control valve. In this way, the accuracy of the application of pressure onto the containers can be ensured using this pressure reservoir.

In a further preferred embodiment, the different pressures are made available to the container via at least two feed lines. It is thus possible for a pressure space to be applied to the head space of the container or to the closure cap, and to supply this pressure space using the two lines. Via this pressure space, the pressure can get into the inside of the container.

In a further preferred embodiment, the apparatus has at least one sealing unit that seals the container and/or the container closure cap during the application. It is thus possible for the container itself to be fed to a sealing surface of an application head. Moreover, however, it would also be possible to lower the head down onto the container. Moreover or in addition it would also be possible to push the container in laterally and to generate in this way the seal between the container and the process head.

In order to apply pressure onto the inside of the container, a seal may be provided at the top of the closure cap. In the prior art, this is realised by feeding in the entire process head. The disadvantage of this is that the head has to be moved together with the entire periphery, which would lead to a shortening of the life of the connections and seals.

Moreover, the sealing movement may be carried out by lifting the containers. As a result, the process head remains permanently in a fixed position and is not damaged as a result of continuous movements. When lifting the bottle, only one bottle holder, for example a clamp, will have to be moved.

It is also possible to realise the sealing between the process head and the container closure cap without moving the two components. In the course of this, an additional intermediate piece is inserted between the two sealing surfaces.

For applying pressure or for compensating pressure in an already closed container, a seal may be provided at the location where the container is supposed to be opened.

In a further advantageous embodiment, the apparatus includes a control unit for at least one of the pressures or one of the pressure stages. Thus, such a control unit may be provided in particular on the reservoir.

Thus, it would for example be possible to provide a pressure transmitter on or in the pressure reservoir, in order to adjust the pressure. Further, the exits to the treatment stations may be provided on the pressure reservoir, in order to adjust the desired end pressure in the containers.

The media distributor used here may be kept rather simple, so that the design of the entire machine may be simplified. As a result of the volume of the pressure reservoir for the low pressure, the desired pressure level may be very accurately adjusted because a decoupling from high pressure will take place. It is therefore possible for the pressure reservoir to be used both for making a high pressure available and for making a low pressure available.

It would further also be possible to sterilise said pressure storage unit, for example using vapour. The use of a control valve for feeding the reservoir may also serve for independently adjusting various design pressures, depending on the desired container pressure.

Thus, any replacement of elements such as screens may be dispensed with. Moreover, an accurate adjustment of the treatment time is no longer as important as it is in the prior art. As a result of a (if necessary additional) use of screens for reducing the pressure from p1 to p2, it would also be possible even in the case of for example an excessively long treatment time, for an excessively high pressure to be reached in the head space, which would lead to an instability of the process.

In a further advantageous embodiment, said application unit for the containers is provided on the transport unit. As mentioned above, a plurality of such application units may here be provided.

In a further preferred embodiment, the pressure storage unit can be cleaned and/or sterilised using a cleaning line and/or a sterilisation line.

In a further preferred embodiment, the apparatus includes a recycling unit that is suitable and designed for at least partially recovering a gaseous medium and in particular the medium described above for applying onto the containers. Thus, nitrogen consumption may be reduced for example by pressure recycling.

In a further preferred embodiment, a piercing position of the penetration unit in relation to the container may be modified and/or adjusted. This may be carried out in particular, but not exclusively, as a result of the fact that a position of the penetration unit and/or of a needle may be modified in relation to the area of the container that is to be pierced and in particular of the container closure cap, in particular perpendicularly to the longitudinal direction of the container.

In this way, for example a closure cap may be pierced at essentially any desired position. The piercing of the container lid may preferably be carried out centrally. However, it is also possible to treat the container closure cap in an oriented position, so that a lid design or closure cap design is not damaged by the needle and/or a welding.

It is also possible to pierce and weld other container areas, for example the bottle bottom. Here, the container is preferably treated via the bottom (e.g. the injection point of the preform), so that no intervention to the container is visible.

In order to modify and in particular to increase the processing speed, the number and also the size of the hole may be varied. The at least one hole may preferably have a diameter of 0.05 mm-4 mm, preferably of 0.1 mm to 2 mm.

Also, the shape of the hole may be varied, for example circular, square, triangular or oval shapes are possible. Alternatively, the shape of the hole may also be a polygon.

In the case of several holes, there is the possibility of welding all of the holes using a welding stamp, or the number of welding stamps corresponds to the number of holes/needles. It is also possible to provide several welding stamps, wherein however at least individual ones of this number of welding stamps weld several holes.

The welding stamp may further include a pattern, for example a logo, a diamond shape or a chequered pattern that is transferred onto the container during the welding process. An advantage here is the minimisation of the external influence by third parties (an imitation of this shape will prove to be difficult).

Moreover, a blank closure cap may be used, and branding may be applied by means of the welding.

For the closing and/or the welding of the pierced hole, several methods may be used. In one method, the containers or closure caps (plastic) may be closed using heat/warmth. However, this may not be carried out exclusively by using microwave heating units, infrared heating units, ultrasonic heating units, soldering irons/heating dies, laser units, hot air application units or the like.

It is a further possibilty to re-use the hole (alternatively or additionally) by supplying material. This may be carried out for example using an application unit for applying adhesives or hot plastics.

In a further embodiment, the apparatus includes a sealing unit that is suitable and designed for sealing a re-closed hole. This seal may serve here both as a mechanical protection of the weld against damage and environmental influences, but also as a warranty of integrity of the product.

It will further also be possible to attach a sealing pattern using a laser.

The present invention is further directed to a method for manufacturing containers filled with liquids and closed, wherein a transport unit is used to transport containers filled with a liquid and closed with a closure cap, and a penetration unit is used to generate an opening in at least one area of the closure cap and/or of the container, and wherein an application unit is used to apply a flowable and in particular gaseous medium to an internal space of the container through the opening and subsequently, the opening is re-closed using a closing unit.

Also with regard to the method, a possibility is therefore proposed to make a suitable method for producing products available.

In a first embodiment, in particular according to the invention, at least one area of the container and/or of the closure cap is sterilised. Also with regard to the method, it is proposed here to carry out sterilisation of an area of the container and/or of the closure cap and/or of an area of the apparatus, such as for example the penetration unit or the application unit and/or the closing unit.

In a preferred method, sterilisation is carried out after perforation of the closure cap or of the container. Sterilisation may then be carried out within that period of time during which the container is opened and has pressure applied to it. However, it would also be possible for sterilisation to be carried out already prior to the perforation of the closure cap and/or of the container.

In a further embodiment according to the invention, the closing unit closes the opening by the effect of ultrasound. As mentioned above, particularly preferably a sonotrode is used for this purpose.

Particularly preferably, at least one component of the closing unit contacts an area of the opening at least at times during the closing process. Particularly preferably, at least one component of the closing unit is fed towards an area of the opening and/or towards the closure cap and/or the area of the container that was perforated.

To this end it is possible to use for example drives, such as in particular pneumatic, electric or hydraulic drives. Apart from that or in addition it would also be possible to use guide cams that allow the respective movements.

In a further preferred method, the closing unit, at least at times, sets at least a section of the container or of the closure cap into mechanical vibration. Particularly preferably, as a result of this mechanical vibration, a material to be heated is heated and in particular melted, so that ultimately closure is achieved. Particularly preferably, an at least partial melting of the area to be closed is achieved as a result of these vibrations.

In a preferred method, a frequency is used for melting or application that is higher than 5 kHz, preferably higher than 10 kHz and preferably higher than 20 kHz. Particularly preferably, a frequency is used that is lower than 80 kHz, preferably lower than 50 kHz, preferably lower than 40 kHz and particularly preferably lower than 35 kHz.

In a further preferred method, the closing process is monitored, at least at times, using a sensor unit. In the course of this, for example a performance of the closing unit or of the sonotrode mentioned above may be measured. It would also be possible to provide a camera that monitors the closing process by means of ultrasound.

In a further preferred method, the ultrasound generation unit has a processing head that can be fed towards the opening and has a surface that faces the opening, in particular a curved or trough-shaped surface.

Preferably, the processing head has a surface that urges molten material in the direction of the opening to be closed. Preferably, the molten plastic material and in particular the molten plastic material of the closure cap is urged, during the melting process, at least at times in the direction of the opening and is urged in particular in a radial direction of the closure cap in the direction of the opening.

In a further preferred method, the ultrasound generation unit is fed towards the closure cap in a direction of movement that encloses an angle with a direction that is perpendicular to the closure cap, which, as mentioned above, is between 5 and 55 degrees, preferably between 10 and 40 degrees, preferably between 15 and 30 degrees and particularly preferably between 17 and 23 degrees. In a particularly preferred embodiment, the ultrasound generation unit, which is in particular a sonotrode, is placed on the material to be processed at an angle of approximately 20 degrees.

In a further method according to the invention, at least one unit of the apparatus is inspected using an inspection unit, and/or at least one parameter is monitored using a monitoring unit, which parameter is characteristic of the manufacture of the filled containers.

In this embodiment it is proposed that either the apparatus or the plant section monitors itself, in particular and not only exclusively, the penetration unit, the application unit and/or the closing unit and/or the treated container is monitored, and here for example a pressure monitoring or the like may be carried out.

Alternatively and/or in addition, the actual treatment process may be monitored.

In a preferred method, at least one value is output that is characteristic of the unit of the apparatus and/or of the manufacture of the filled containers. Particularly preferably, the apparatus is controlled on the basis of this value.

In a further preferred method, the generation of the opening in the closure cap and/or the application and/or the closing as mentioned above is/are carried out in a first working operation of the apparatus.

In an embodiment according to the invention, at least one unit of the application unit is cleaned and/or sterilised in a second working operation by means of a cleaning and/or sterilisation medium. In this embodiment it is generally proposed that sterilisation and/or cleaning of units and/or plant sections is carried out. This cleaning and/or sterilisation may here be carried out in particular by means of a cleaning and/or sterlisation medium.

In a preferred method, cleaning and/or sterilisation is carried out by means of a flowable cleaning and/or sterilisation medium. This may be for example, as mentioned above, water vapour, hydrogen peroxide of the like.

In a further preferred method, the cleaning and/or sterilisation unit is made available using a supply unit that is arranged to be stationary. Particularly preferably, this supply may be carried out during a movement of the application unit. However, it would also be possible for the supply of the cleaning and/or sterlisation medium to be carried out in a stationary condition of the application units. Particularly preferably, the cleaning and/or sterlisation agent is made available via the same paths as the flowable medium that is applied to the containers. Particularly preferably, the cleaning and/or sterilisation medium is made available via a rotary distributor.

In a further preferred method, also a pressure reservoir of the apparatus is cleaned using the cleaning and/or sterilisation medium.

Further, it is preferably also possible for several feed lines for the flowable medium to be cleaned using the cleaning and/or sterilisation medium.

In a further embodiment of the method according to the invention, a first pressure and a second pressure, which deviates therefrom, of the flowable medium is applied onto the container by the application unit.

Preferably, initially a higher pressure and subsequently a lower pressure are applied to the container.

In a preferred method, the low pressure is made available by a pressure storage unit.

Further advantages and embodiments will become evident from the attached drawings, wherein:

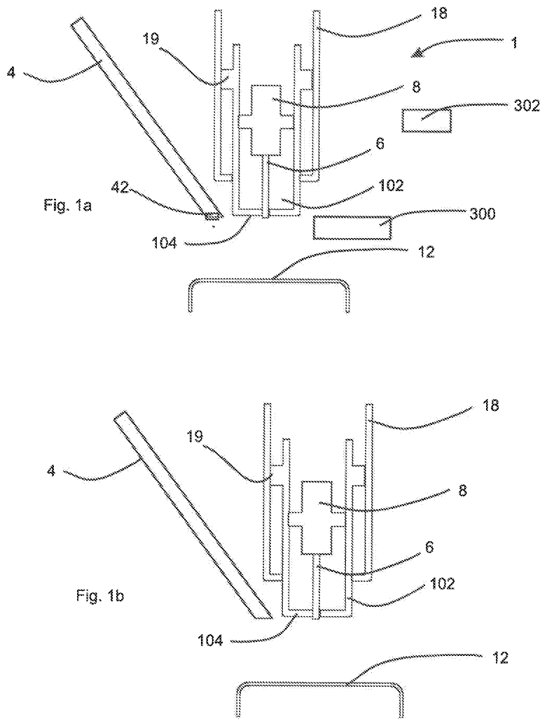

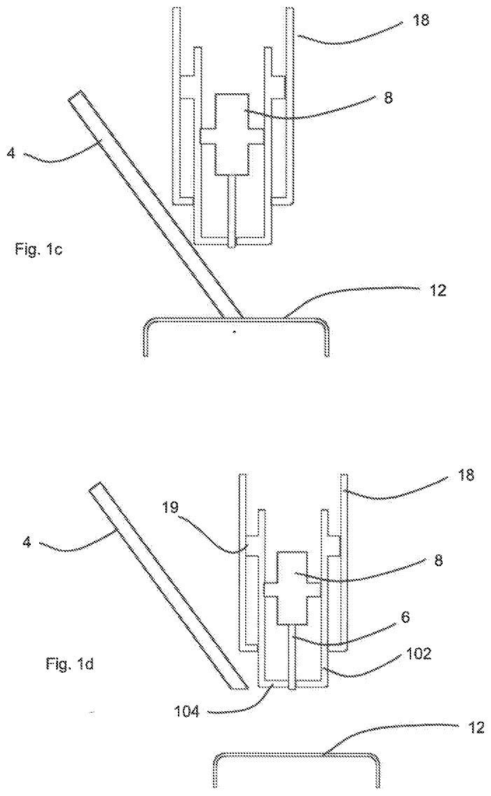

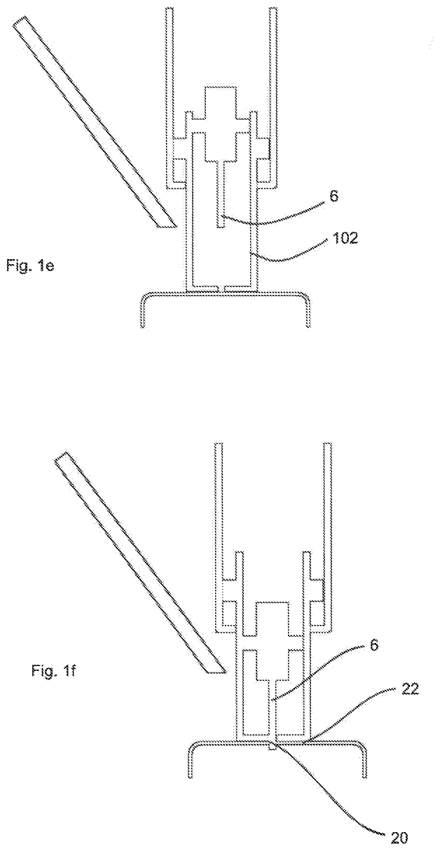

FIG. 1a-1h show schematic views of an apparatus according to the invention for illustrating a method to be carried out;

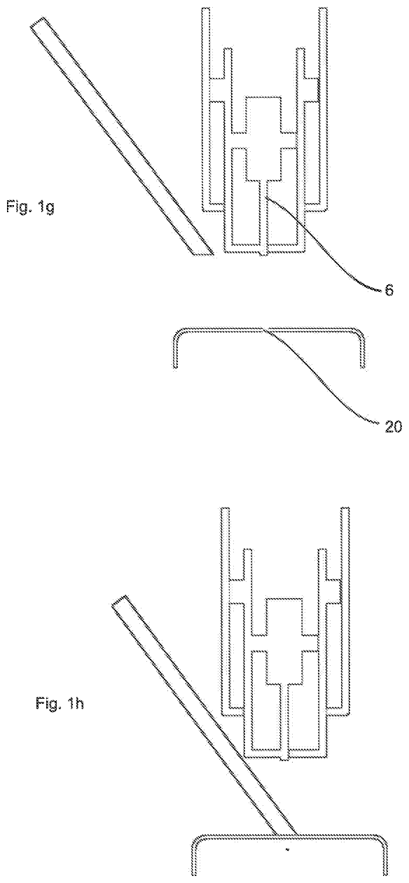

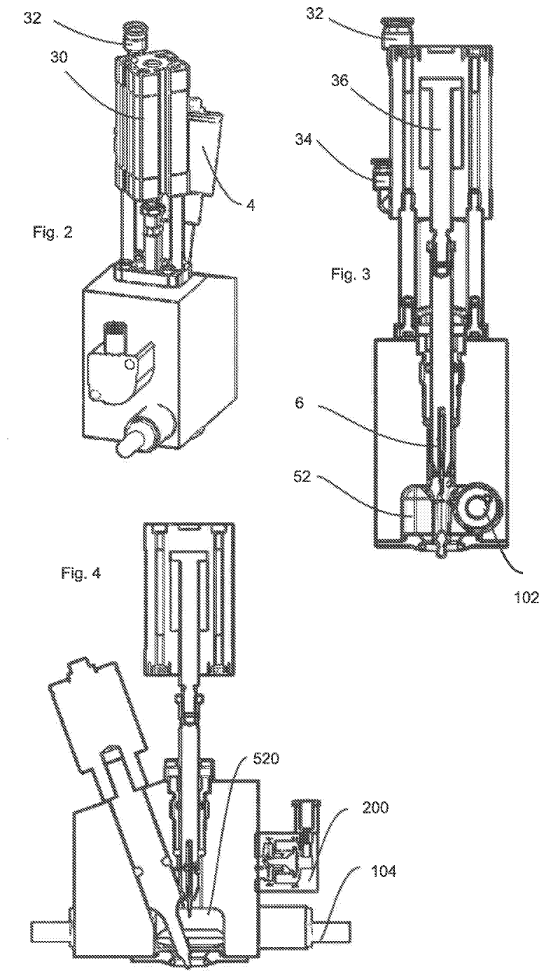

FIG. 2 shows a view of an apparatus according to the invention in a schematic illustration;

FIG. 3 shows a lateral view of the illustration shown in FIG. 2;

FIG. 4 shows a further lateral view of the apparatus shown in FIG. 2;

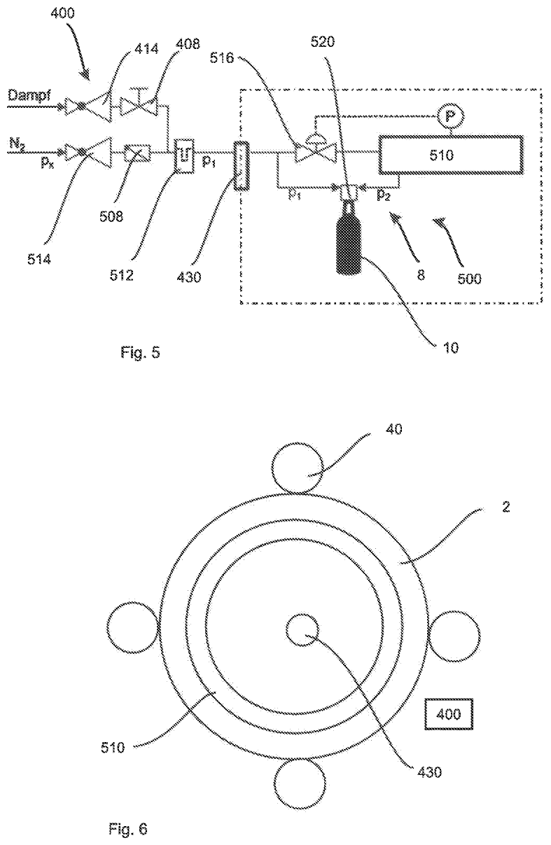

FIG. 5 shows a circuit diagram for illustrating a method according to the invention;

FIG. 6 shows a roughly schematic representation of an apparatus according to the invention;

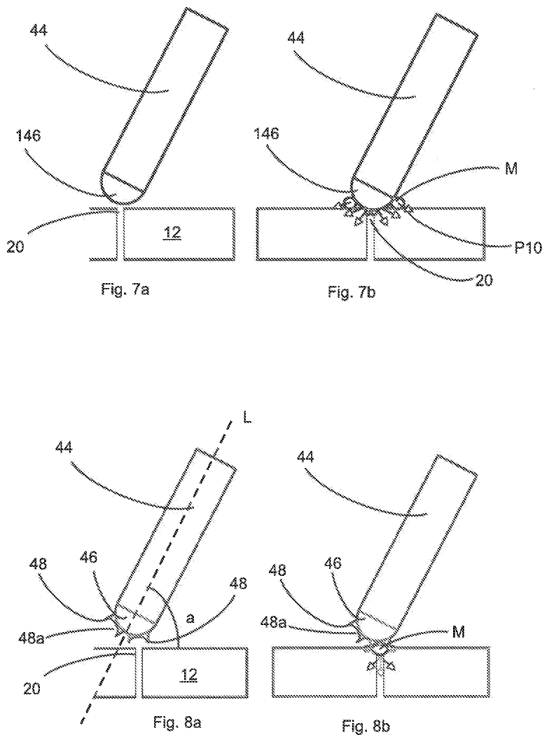

FIG. 7a, b, show two embodiments of ultrasound generation units according to the applicant's internal prior art; and

FIG. 8a, b show two views of a particularly preferred embodiment of ultrasound generation units.

FIG. 1a shows a schematic view of an apparatus 1 according to the invention for treating containers. Only a closure cap 12 of the container is shown here. The apparatus according to the invention has a penetration unit 6 that is implemented here as a needle and that is supposed to pierce a predetermined area of the closure cap 12. This penetration unit 6 is provided here on a drive unit so as to be movable, and can thus, according to FIG. 1a, be fed towards the closure cap in a vertical direction and can pierce the latter.

Reference numeral 104 identifies a guide unit that is used for guiding the penetration unit 6. Reference numeral 102 roughly identifies a guide cylinder, within which the penetration unit 6 is movable with its drive unit 8.

Reference numeral 19 identifies a further drive unit that can be generally moved relative to a housing 18 also in the vertical direction. At the same time, a pressure may be applied to the container by the application unit 8. Reference numeral 4 identifies a closing unit that is designed to re-close the container closure cap after piercing and filling with the gas.

In one embodiment, this closing unit may include an ultrasound generation unit 42. This may be applied to the closure cap and may heat the latter locally by means of vibrations to such a degree that the (plastic) material of the closure cap 12 melts.

Reference numeral 300 identifies in a rough schematic form an inspection unit that is suitable and designed to inspect units of the apparatus 1 and/or to inspect a working result, for example a bored hole. It is possible here for such inspection units to be arranged to be stationary and to be moved past the apparatus as shown in FIG. 1a.

However, it would also be conceivable for the inspection unit to be installed stationary relative to the apparatus shown in FIG. 1a, for example on the transport unit (not shown), on which the apparatus itself is disposed.

Reference numeral 302 identifies roughly schematically a monitoring unit that monitors the process described above, for example by monitoring pressures, temperatures or other process parameters.

In the situation shown in FIG. 1b, no component of the apparatus is fed towards the closure cap of the container, so that this marks the beginning of a corresponding method.

In the view shown in FIG. 1c, the closing unit, such as a tempering element, is initially fed towards the closure cap, for example in order to melt or soften the latter. However, this method step is optional.

In the situation shown in FIG. 3d, the closing unit is moved back again.

In the situation shown in FIG. 1e, the element 102 is initially fed towards the closure cap 12. In this way, for example sterillsation of the closure cap 12 may be achieved, by sterilising for example the surrounding areas of the area in which the opening is supposed to be generated, which may be carried out for example by means of UV light, as will be explained in more detail below, or by means of the effect of heat or also by means of a sterilisation medium.

In the situation shown in FIG. 1f, the penetration unit 6 is used to pierce a hole into the closure cap of the container. In the situation shown in FIG. 1g, the penetration unit is retracted. As a result, an opening or a hole 20 has now been generated in the closure cap 12. In the situation shown in FIG. 1h, this hole 20 is re-closed. This may be carried out, as mentioned above, by melting the material, however a sonotrode may also be used, which effects an even more favourable closing of the opening 20.

FIG. 2 shows a view of an apparatus according to the invention. Here, a housing 30 is provided that may have for example a linear drive unit for a needle or the sonotrode. Reference numeral 4 again identifies the closing unit, which as shown in FIG. 2 is guided at an angle and can therefore also be fed to the container (not shown) at an angle. Reference numeral 32 identifies a pressurised air feed that is used for actuating the pneumatic drive.

In the situation shown in FIG. 3, apart from the pressurised air feed 32, also a second connection 34 can be seen, which can altogether effect the movement of the piston 36.

Reference numeral 6 in turn identifies the penetration unit and reference numeral 52 identifies a temperature sensor that can monitor for example the temperature of the closure cap of the container.

Reference numeral 102 identifies a sterlisation unit that is here implemented as a pulsed UV lamp and that sterilises the area of the opening generated or to be generated.

In the situation shown in FIG. 4, a valve block is provided that may be used for feeding the gas, for example nitrogen. Moreover, this valve block may also be sterilised using a sterilisation gas. Moreover, sterilisation using H₂O₂ is also possible.

Reference numeral 104 identifies a cooling unit for cooling the UV lamp or generally the sterilisation unit. This may for example be liquid cooling.

Reference numeral 520 identifies a pressure application space in order to seal the area between the closure cap and the pressurised air application and in order to apply in this way the overpressure on the container closure cap and thus also the container (not shown).

FIG. 5 shows a circuit diagram layout of an apparatus according to the invention having a treatment station. This shows a container 10 that has pressurised air applied thereto. Here again, an application chamber 520 is provided that can supply pressures p1 and p2 using two pressurised air lines. A pressure reservoir 514 may be used to supply initially a pressure Px to a rotary distributor 430 via a control stage 508 and a control unit 512.

This rotary distributor 430 distributes the pressurised air to the individual containers or the individual application units. Reference numeral 500 identifies the application unit in its entirety.

Reference numeral 510 identifies a pressure storage unit that is provided for storing a certain pressure, either the higher pressure p1 or the lower pressure p2.

Reference numeral 516 identifies a control valve that is suitable for controlling the pressure P exiting the reservoir to the individual containers.

Moreover, also the cleaning function of the apparatus is shown. Here again, a reservoir 414 is provided that can make available for example a cleaning agent such as vapour. Reference numeral 408 identifies a valve that can effect the supply of vapour into the unit 512, the rotary distributor 430, but also the individual lines of the application unit 500.

FIG. 6 shows a schematic view of an apparatus 1 according to the invention. Here, a transport unit 2 is provided that may be implemented for example as a rotary carrier. On this carrier, a plurality of treatment stations 40 is provided, which may include here, as mentioned above, the individual units such as the application unit and the like.

Reference numeral 430 in turn identifies a rotary distributor, and reference numeral 510 shows roughly schematically the reservoir that may be used for providing or storing a pressure stage.

FIGS. 7a, 7b show a view of an ultrasound generation unit known from the applicant's internal prior art. Each of these have a body 44 as well as a head 146 which have, as can be seen here, a curved and in particular hemispherical outwardly curved surface. As mentioned, this circular sonotrode shape may contribute towards achieving a beautiful weld, however, as is shown in particular in FIG. 7b, it may occur that molten material is urged away towards the outside, i.e. away from the opening, so that the latter is therefore not reliably closed. Reference sign M identifies molten material of the container lid. It can be seen that this is urged away from the opening as indicated by the arrow P10.

FIGS. 8a, 8b show an advantageous embodiment of the sonotrode. Here, two sonotrode elements 48 with surfaces 48a are provided on the head 46. The tip or the surface, which is shown on the left-hand side in FIG. 8a, is not used here for carrying out a working process but is provided for reasons of symmetry. Reference sign L relates to the longitudinal direction of the sonotrode (as well as to the direction in which the sonotrode is fed towards the closure cap). Thus, the concave shaping is here present on both sides of the sonotrode (in relation to the longitudinal direction L).

As shown in FIG. 8b, the concave shaping achieves an urging of a vast majority of the molten material M in the direction of the opening 20, or an urging of the material into this opening, so that as a result a secure sealing of the opening 20 is achieved.

Reference sign a identifies the angle under which the sonotrode is fed towards the lid.

The applicant reserves the right to claim all of the features disclosed in the application documents as being essential to the invention, insofar as they are novel over the prior art either individually or in combination. It is further pointed out that whilst the individual figures also describe features that may be advantageous if taken by themselves, however, a person skilled in the art will immediately recognise that a certain feature described in a figure may be advantageous even without adopting other features from this figure. A person skilled in the art will further recognise that also advantages may be achieved by a combination of several features as shown in individual or in different figures.

### LIST OF REFERENCE NUMERALS

1 Apparatus
2 Transport unit
4 Closing unit
6 Penetration unit
8 Application unit
Container
12 Closure cap
18 Housing
19 Drive unit
20 Hole
30 Housing
32 Pressurised air supply
34 Second connection
36 Piston
40 Treatment stations
42 Ultrasound generation unit
44 Body of the ultrasound generation unit
46 Head of the ultrasound generation unit
48 Sonotrode element
48a Surface
52 Temperature sensor
102 Guide cylinder
102 Element
102 Sterilsation unit
104 Guide unit
104 Cooling unit
408 Valve
414 Reservoir
430 Rotary distributor
300 Inspection unit
302 Monitoring unit
500 Application unit
508 Control stage
510 Pressure storage unit
510 Reservoir
512 Control unit
514 Pressure reservoir
516 Control valve
520 Pressure application space
P1 Higher pressure
P2 Lower pressure
PX Pressure
M Molten material
P10 Urging direction of the molten material
a Angle of the feed direction relative to the direction that is perpendicular to the closure cap 12

1. An apparatus for manufacturing filled containers comprising a transport unit configured for transporting containers that are filled with a liquid and are closed with a closure cap, a penetration unit configured for generating an opening in at least an area of the closure cap and/or of the container, an application unit configured to apply a flowable and in particular gaseous medium to an internal space of the container through the opening, and a closing unit configured to close the opening, wherein
the closing unit has an ultrasound generation unit.

2. The apparatus as claimed in claim 1, wherein
the closing unit has a feed unit configured to feed at least one component of the ultrasound generation unit towards the opening.

3. The apparatus as claimed in claim 1, wherein
the ultrasound generation unit includes a sonotrode.

4. The apparatus as claimed in claim 3, wherein
the ultrasound generation unit is integrated, at least at times, into the container or the stamp contacting the closure cap.

5. The apparatus as claimed in claim 1, wherein
the ultrasound generation unit includes a generator unit that is configured for generating ultrasound having a frequency of more than 20 kHz, and/or in that the ultrasound generation unit includes a generator unit that is configured for generating an ultrasound having a frequency of less than 80 kHz.

6. The apparatus as claimed in claim 1, wherein
the apparatus has a sensor unit configured to determine at least one parameter that is characteristic of the ultrasonic welding process.

7. The apparatus as claimed in claim 1, wherein
the ultrasound generation unit has a processing head that is fed towards the opening, with a surface that is turned towards the opening, which surface is configured for urging molten material in the direction of the opening.

8. The apparatus as claimed in claim 7, wherein
the surface is curved and is in particular curved to be concave.

9. The apparatus as claimed in claim 7, wherein
the surface has a spherical shape.

10. The apparatus as claimed in claim 1, wherein
the ultrasound generation unit is configured to fed towards the opening in such a way that a longitudinal direction of the ultrasound generation unit encloses an angle (a) with a direction that is perpendicular to a surface of the closure cap, which is between 5° and 50°, preferably between 10° and 40°, preferably between 15° and 30° and preferably between 17° and 23°.

11. A method for manufacturing containers that are filled with liquids and closed, wherein a transport bast is used to transport containers filled with a liquid and closed with a closure cap, and a penetration unit is used to produce an opening in at least an area of the closure cap and/or of the container, and an application unit is used to apply a flowable and in particular gaseous medium into an internal space of the container through the opening, and subsequently the opening is re-closed using a closing unit,
wherein
the closing unit closes the opening by an effect of ultrasound.

12. The method as claimed in claim 11,
wherein
at least one component of the closing unit contacts an area of the opening, at least at times, during the closing process.

13. The method as claimed in claim 11, wherein
the closing unit sets, at least at times, at least a section of the container or of the closure cap into mechanical vibration.

14. The method as claimed in claim 1, wherein
the closing process is monitored, at least at times, by a sensor unit.

15. The method as claimed in claim 11, wherein
the ultrasound generation unit has a processing head that is fed towards the opening, with a curved surface that faces the opening.

16. The apparatus as claimed in claim 2, wherein the ultrasound generation unit includes a sonotrode.

17. The apparatus as claimed in claim 16, wherein the ultrasound generation unit is integrated, at least at times, into the container or the stamp contacting the closure cap.

18. The apparatus as claimed in claim 8, wherein the surface has a spherical shape.

19. The method as claimed in claim 12, wherein the closing unit sets, at least at times, at least a section of the container or of the closure cap into mechanical vibration.

20. The method as claimed in claim 13, wherein the closing process is monitored, at least at times, by a sensor unit.
